(19) United States
(12) Patent Application Publication
(10) Pub. No.: US 2025/0322449 A1
(43) Pub. Date: Oct. 16, 2025

(54) SYSTEM AND METHOD FOR HIDDEN THRESHOLD AUCTIONS

(71) Applicants: Emily CAFAZZO, New York, NY (US); William Matthew HAZELTON, New York, NY (US)

(72) Inventors: Emily CAFAZZO, New York, NY (US); William Matthew HAZELTON, New York, NY (US)

(21) Appl. No.: 18/788,795

(22) Filed: Jul. 30, 2024

Related U.S. Application Data
(60) Provisional application No. 63/632,669, filed on Apr. 11, 2024.

(51) Int. Cl. G06Q 30/08

(52) U.S. Cl. CPC G06Q 30/08

(57) ABSTRACT

Systems and methods for hidden threshold auctions may be provided. In an exemplary embodiment a method for hidden threshold auctions may include generating one or more auction postings, where each auction posting including at a hidden threshold value. The auction platform may receive third party financial information for each of the one or more communication devices. The platform may further periodically receive one or more bids from the one or more communication devices and determine a highest bid. Once a highest bid is determined the platform may automatically withhold from the third party financial institution money equivalent to up to the highest bid, compare the highest bid against the hidden threshold value in substantially real-time and determine the highest bid exceeds the hidden threshold value. The auction may be automatically executed based on the highest bid.

### BACKGROUND

In recent years, and particularly with the advent of the Internet, auctioning has enjoyed increased attention and participation from the population at large. This is demonstrated by the success of such on-line Internet auctioning companies as EBAY and ONLINE.COM. These Internet auction companies allow items of any value to be placed for bid on their web sites. Each item submitted for sale is assigned an auction session, which includes a starting time (or opening) and a closing time. Bids are then accepted electronically as long as the auction session is open. At the close of the auction session, the item is awarded to the highest bidder.

Other internet commerce sites such as StockX work as exchanges, where the items are treated as securities where both the asking and bid prices are viewable by both the buyer and seller. Participants then place bids until a sale is contracted, however all information is fully disclosed and viewable by both sides.

However, current online auction systems with a given closing time and no other way to otherwise end the auction have a number of issues, for example it encourages bidders to try to “snipe” the auction by placing a bid in the last few seconds of the auction window. This can discourage bidders from placing reasonable offers early on in the bid window, and also encourages the use of botting or other undesirable methods to win the auction. Additionally, having all information known creates a shell game where bidders are trying to game the system, rather than bidding based on how they actually value the item for sale.

Additionally, e-commerce platforms and concept stores that facilitate the buying and selling of used items between customers have grown increasingly popular due to shifting customer interests and demands. For example, people have an increased desire for sustainable resold items and goods, there is a growing acceptance of second-hand items as being fashionable or desirable, and social trends have fostered high-touch interactions with all facets of electronic and brick and mortar retail.

However, these existing platforms have various shortcomings. Concept stores that aggregate inventory across brands tend to function as traditional retail-holding inventory and selling at “sale” or liquidation prices to move older goods. Secondhand platforms are prevalent and vary as far as target customers, goods offered, and mechanisms for sale. However almost all either operate as a pure auction or pure retail platform, each with their own shortcomings. Pure auctions can be an inefficient way to sell goods where there isn't a very broad audience and/or a long-enough time frame to gather or assess market interest; as a result, not enough information is provided to the seller to determine what the correct price for a given good is. Retail models on the other hand suffer from an inability for buyers to express interest without actually buying the good for sale, and for sellers to use such information to modify selling price accordingly. Finally, there is always the chance that the buyer will pull their bid or purchase before the transaction is completed, increasing inefficiencies within the systems. Notably, existing resale sites rely on a multi-step execution for bids, wherein an offer is submitted, accepted, and then payment is processed. Examples of platforms currently using a multistep execution process include Vestiaire Collective, whereby a customer expressing item-interest via a bid has final optionality of whether or not to submit payment once a bid (“offer”) has been accepted on a platform. This is highly inefficient for closing sales for many reasons-as retail shopping, particularly for specific luxury goods, involves well-studied psychological factors and specific consumer behaviors. Adding complications, time or steps to a sale process runs contra to the basics of consumer psychology.

### SUMMARY

Systems and methods for hidden threshold auctions may be provided. In an exemplary embodiment a method for hidden threshold auctions may include generating one or more auction postings on an auction platform, where each auction posting includes at least a hidden threshold value. The method may further include setting an auction timer for each of the one or more auction postings, where the auction timer determines a time window for the auction and displaying the list value to one or more communication device each coupled to one or more bidders. The auction platform may further receive third party financial information associated with a third party financial institution communicatively coupled to the auction platform for each of the one or more communication devices. The platform may further periodically receive one or more bids from the one or more communication devices and determine a highest bid. Once a highest bid is determined the platform may automatically withhold from the third party financial institution money up to the amount of the highest bid, compare the highest bid against the hidden threshold value in substantially real-time and determine the highest bid exceeds the hidden threshold value. Upon the determination that the hidden threshold value has been exceeded the timer may be stopped and upon expiration of the timer, the auction may be automatically executed based on the highest bid. In some embodiments the auction may further terminate if the bid is accepted by the seller, the bid is equal to list price, and/or if the bid is within the execution range.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary hidden threshold auction.

FIG. 2 shows an exemplary layered hidden threshold auction.

FIG. 3 shows an exemplary auction according to an embodiment.

FIG. 4 shows an exemplary selling metrics display based on bids placed

FIG. 5A shows an exemplary item with a scannable tag according to an embodiment.

FIG. 5B shows scanning of an item with a handheld device according to an embodiment.

FIG. 5C shows a scanned item being displayed on a platform for bids to be placed according to an embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

Further, many embodiments are described in terms of sequences of actions performed by, for example, elements of a computing device. It may be recognized, by those of ordinary skill in the art, that various sequences of actions can be performed by specific circuits (e.g. application specific integrated circuits (ASICs)) and/or by program instructions executed by at least one processor. Additionally, the sequence of actions, described herein, may be embodied within a form of computer-readable storage medium such that execution of the sequence of action enables at least one processor to perform the functionality described herein. Furthermore, the sequence of actions, described herein, may be embodied in a combination of hardware and software assets (such as a SaaS-based platform). Thus, various aspects of present invention may be embodied in several different forms, all of which have been contemplated to be within the scope of the claimed subject matter. In addition, for each of the embodiments described herein, any corresponding embodiments may perform the described action, for example, “a computer configured to”.

In one or more exemplary embodiments systems and method for hidden threshold auctions may be provided.

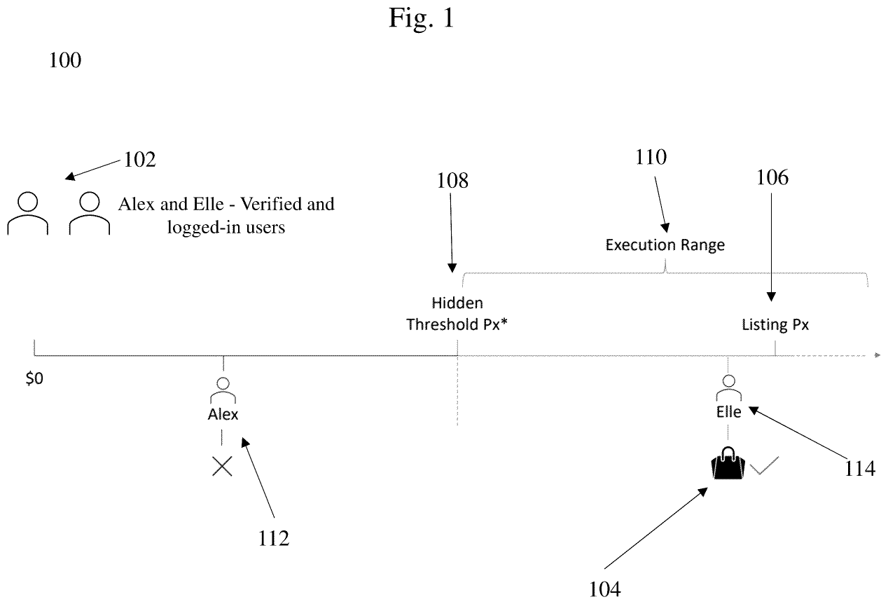

Referring to FIG. 1, an exemplary hidden threshold auction 100 may be shown and described. The auction may be part of an auction platform, which may be, for example, a website, app, etc. The auction platform may include a plurality of users 102, who may be, for example, buyers and sellers. In some embodiments the users 102 may have a user account with the auction platform and may be verified and/or logged in to the account. In some embodiments the user accounts may be required to provide authentication information and one or more valid methods of payment, for example credit card numbers. The auction 100 may include an item for auction 104, which may be, for example but not limited to, a clothing item, fashion accessory, electronics item, household item, furniture, or any other item that may be listed by a seller on the auction platform.

In some embodiments the seller may be able to set various prices or thresholds on the auction 100. The seller may be able to set a list price 106, which may be a price that is displayed and for which any buyer on the auction platform may be able to guarantee purchase the item for auction 104. The seller may also be able to set a threshold price 108, which may be hidden from any user other than the seller. The threshold price 108 may be set as a percentage of the list price 106 and/or may be set as a specific monetary value. It may be understood that the threshold price 108 may be lower than the list price 106. An execution range 110 may then be set, where the execution range is any price, or percentage, above the threshold price 108. One or more buyers may then place bids on the item to be auctioned 104 or may “lift” the item outright, which may be understood to mean purchasing the item for the full list price 106. In an embodiment the bid may be expressed as a percentage of the list price 106, for example the buyer bid may be bid at 80% of the list price. If the buyer bid is not within the execution range 110 (i.e. below the threshold price 108) then the bid may be rejected 112. If the bid is within the execution range 110 (i.e. above the threshold price 108) then the bid may be automatically accepted 114, and the item listed for auction 104 may be sold and the transaction may be automatically executed and finalized. It may be understood that in some embodiments the threshold price 108 and execution range 110 may be viewable only by the seller, and any sold listing in the execution range 110 may be disclosed as data points to the seller.

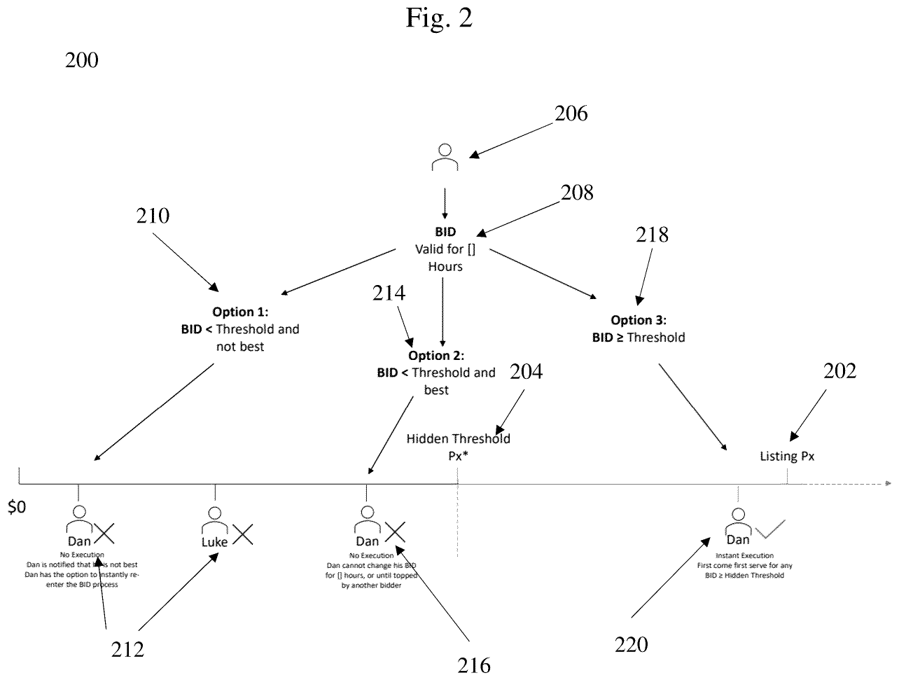

Referring to FIG. 2, an exemplary layered hidden threshold auction 200 may be shown and described. The layered auction 200 may be part of an auction platform, which may be, for example, a website, app, etc. The auction platform may include a plurality of users, who may be, for example, buyers and sellers. The layered auction 200 may include an item for auction, which may be, for example but not limited to, a clothing item, fashion accessory, electronics item, household item, furniture, or any other item that may be listed by a seller on the auction platform.

In some embodiments the seller may be able to set various prices or thresholds on the layered auction 200. The seller may be able to set a list price 202, which may be a price that is displayed and for which any buyer on the auction platform may be able to guarantee purchase the item for auction. In some embodiments no list price is provided and the bids are placed “blind” on the item, with a set threshold price to execute the transaction if exceeded. The seller may further set a hidden threshold value 204, which may be hidden from any user other than the seller. One or more bidders 206 may place bids on the item for sale. Each bidder may select a bid price and a duration that the bid is valid for 208. In some embodiments the duration of the bid is valid 208 may be set by the system and/or the seller and/or buyer. In some embodiments the duration of bid validity 208 may be set automatically by the system and/or determined in another fashion, e.g. by the seller, based on the category of price or item being sold, etc.

In a first scenario 210 the bid price may be below the threshold price 204, and also below the best current bid. In the first scenario 210 the bid may not be executed, and the bidder may be notified that their bid is not the best bid 212. In some embodiments the bidder may then be given the option to instantly re-enter the bid process with a higher bid, in other embodiments the bidder may be prevented from placing another bid on the same item for a predetermined period of time after their bid expires. In some embodiments the bidder may be limited in how many additional bids may be submitted, for example the bidder may be notified that they have one additional bid they may place, which may be understood to prevent gaming of bids. In other embodiments the bid limitations may be a different amount, for example 3, 5, etc. In a second scenario 214 the bidder may enter a bid that is below the threshold value 204 but is the current best bid. The bid may not be executed, but the bidder's offer may be held for the hours of bid validity 208 or until topped by another bidder 216. In some embodiments the seller may be notified of the current best bid and may be able to accept the current best bid within the hours of bid validity 208. Once the hours of bid validity 208 are up the bidder may be notified and may be given the option to submit another bid, the additional bid may be required to be higher than the previous bid in some embodiments. In a third scenario 218 the bidder may place a bid higher than the hidden threshold 204. The bid may be instantly executed for the bid based on which bidder first submitted a bid higher than the hidden threshold 204, and the auction may be closed.

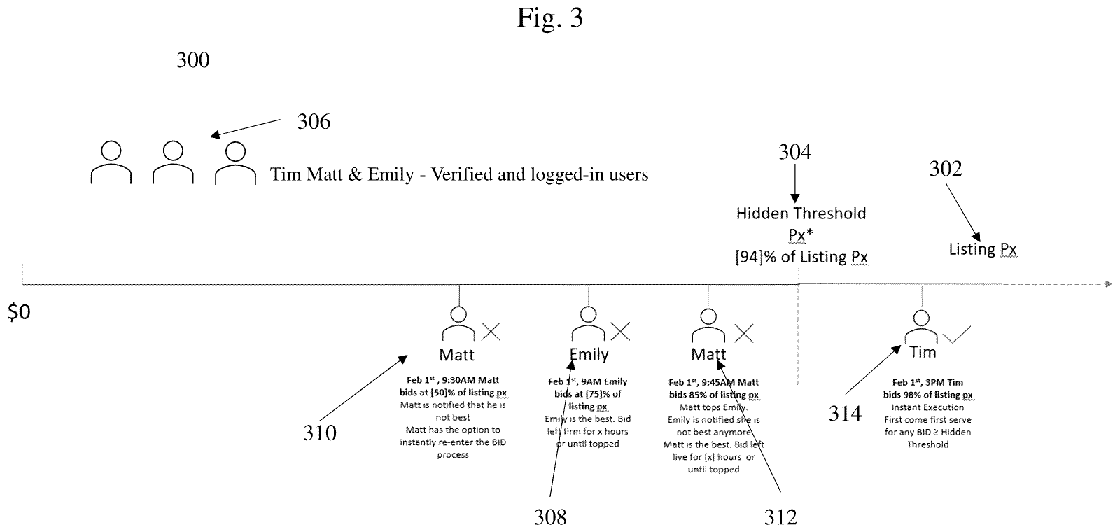

For purposes of illustration, and referring to FIG. 3, an example auction may now be described. A seller may list a purse with a list price 302 of $1,000. The seller may also set the hidden threshold 304, for example to 94% of the listing price 302. Three bidders, for example bidder Tim, bidder Matt, and bidder Emily may each place a bid on the purse with a bid duration of 24 hours. Emily may place a first bid of 75% the listing price 302 at 9AM 308, as the current only bid Emily's bid is the best bid but is below the threshold 304, and so will be left until the bid expires or another bid is placed that beats it. Matt may place a bid of 50% of the listing price at 9:30 AM 310. Since Matt's bid is less than an existing bid, Matt may be notified that his bid is not the best, and may be given the option to re-enter the bid process. Matt may place a new bid of 85% the listing price at 9:45 AM 312. Since Matt's new bid is higher than Emily's (the previous highest bid), Emily may be notified she is not the best bid anymore and Matt may be notified he has the best bid. In some embodiments Emily's bid may be killed and Emily may be notified, and further may be given the option to bid again. Matt's bid may be valid until the bid expires or is topped. Finally, Tim may place a bid for 98% of list price at 3PM 314. Since Tim's bid is over the hidden threshold 304, the transaction may be instantly executed, and once the bid has been executed Matt's bid may be terminated as the bid process has closed.

In some embodiments a “shopping spree” function related to the auction platform may be included. A user may establish a budget in addition to typical one-at-a-time bidding in order to bid on multiple items across the site. The budget may include at least a budget amount and a budget timeframe. The platform may then track the user's spending and bids across the platform based on the set budget and time frame. In some embodiments the budget set may also be increased by the seller.

In some embodiments the user may bid on a plurality of items even where the total outstanding bids total more than the provided budget. As outstanding bids are accepted and items are purchased on the platform, via ML, AI, or another algorithm, the platform may discard user bids on items whose levels exceed the remaining bid budget. In some embodiments a hold amount may be placed on the user's account or payment methods lower than or equal to the budget amount.

As an example, a user may set a bid budget of $6,000 over the course of a day. The user may place a $5,000 bid for item A at 11:00 AM, a $1,000 bid for item B at 11:15 AM, and a $2,000 bid for item C at 11:45 AM. At 12:15 the user may get a notification that the seller for item C has accepted their bid. The bid for item A may then be automatically cancelled, as the budget now only has $4,000 left after the sale of item C, and the item A bid is more than that.

In some embodiments an AI-driven sales execution may be provided. In an embodiment an Artificial Intelligence and/or Machine Learning model may match a buyer and seller to achieve a desired net price for each side of the transaction by, for example, modifying commission based on one or more model inputs. For exemplary purposes, in a scenario a seller may set an undisclosed limit of 95% of full price as a clearing level/hidden threshold, and a buyer may make a bid of 92% of list price. If the highest bid is below the hidden threshold the AI and/or ML process may then close the gap between the hidden threshold price and the highest bid by squeezing commission to the platform to close the sale. Factor inputs may include bid delta relative to undisclosed threshold, bid delta relative to last bid, listing age, buyer spending profile, number of listings for the specific seller, or other metrics.

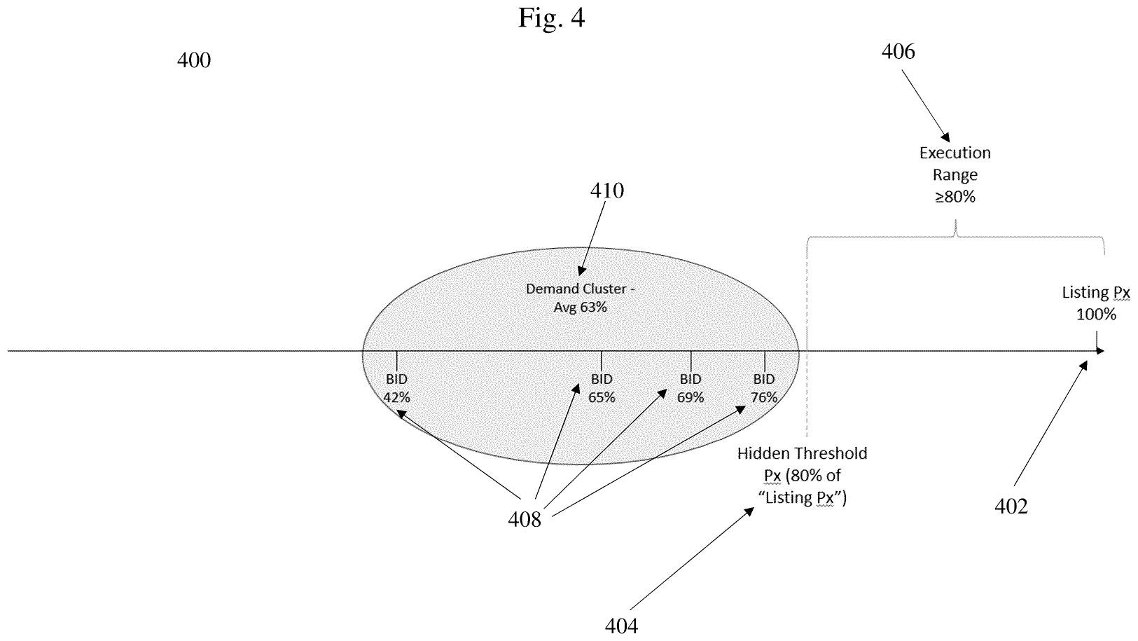

Referring to Exemplary FIG. 4, in some embodiments sellers may be provided selling metrics based on bids placed on listed items 400. It may be understood that during the bidding process some or all data, for example bid amounts, bid times, number of bids, etc. may be captured and recorded. For example, a graphic or other display of selling stats may be displayed to the seller. In an embodiment the graphic or other display may include the item, the item listing price 402, the item hidden threshold 404, and the item execution range 406. The metrics may further include a plurality of customer bids 408, for example if 4 bids were placed of 42%, 65%, 69%, and 76%. Further statistics may be automatically determined and displayed, for example a demand cluster display 410, which may show the average bid price. In other embodiments other stats may be displayed, such as mean bid, total number of bids on multiple items, historical bids for an item, etc. In other embodiments data for similar products within the platform may be cross checked and a price suggestion for the execution threshold and/or list price may be given.

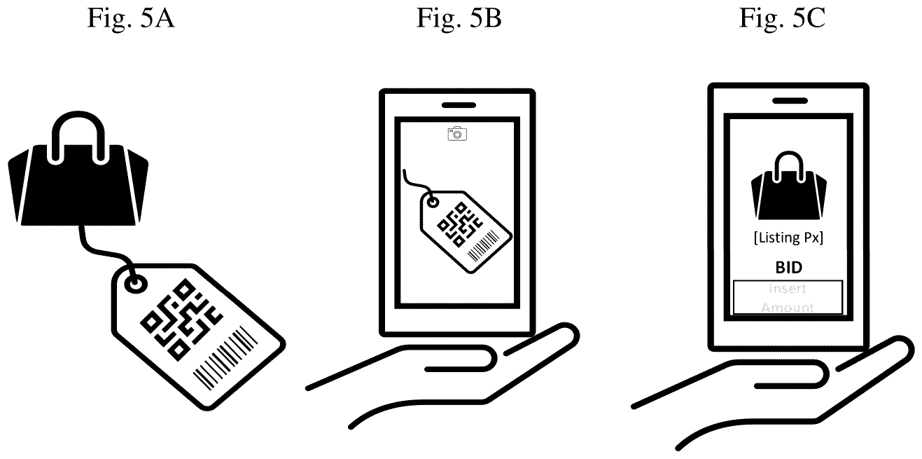

Referring generally to exemplary FIGS. 5A-5C, in some embodiments users may be able to scan an item listed on the platform via QR code or via barcode/UPC/SKU to be able to bid an item off-the-shelf in a physical retail location. When the user scans the item via a mobile device, the mobile device may access the platform and direct them to the specific item of interest. Geofencing or geolocating may be used to link a specific item in a store to the particular item accessed on the app by crossing location with a universal identifier, such as UPC. If specific and unique inventory information is captured-by SKU or QR, for example, the need for crossing item identifier with location may be unnecessary or redundant.

In some embodiments the brick and mortar retailers may be the seller, with in-store items having a list price that may be equivalent to the on-the-shelf price as advertised or listed, with hidden threshold prices available by utilizing the platform. FIG. 5A-5B may show a verified user scanning an item with a handheld/smartphone device via, for example, a QR or SKU code, and FIG. 5C may show the scanned item being displayed on the platform for bids to be placed. In some embodiments the user may be requested to verify their location, for example where generalized identifiers are used.

In some embodiments the auction platform may communicate with a third party financial institution, for example a bank account or a credit card company. When a user places a bid that is the current highest bid, a hold may be automatically placed on user funds up to the highest bid placed, for example by placing a hold on the payment account and/or by moving funds to an escrow account or similar. It may be understood that the funds may be required in order for the bid to be effectively placed. It may further be understood that when a bid “wins”, whether by passing the hidden threshold or by being the top bid as the auction expires, the funds may be automatically transferred to the seller without further action by the seller. In some embodiments when the purchase is completed funds may be automatically taken from the buyer, but may be held and only released to the seller when the buyer confirms receipt of the item.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A non-transitory computer readable medium with computer executable instructions stored thereon executed by a processor to perform a method for hidden threshold auctions comprising:
generating a plurality of auction postings on an auction platform, each auction posting including at least a hidden threshold value;
setting an auction timer for each of the plurality of auction postings, the auction timer determining a time window for the auction;
displaying the one or more auction postings to one or more communication device each coupled to one or more bidders;
receiving third party financial information associated with a third party financial institution communicatively coupled to the auction platform for each of the one or more communication devices;
receiving one or more bids from the one or more communication devices, each of the one or more bids having a duration of validity after which each of the one or more bids expires;
determining a highest bid;
automatically withholding from the third party financial institution money up to the highest bid;
comparing the highest bid against the hidden threshold value in substantially real-time;
determining the highest bid exceeds the hidden threshold value;
upon the determination that the hidden threshold value has been exceeded stopping the timer for one of the plurality of auction postings; and
upon expiration of the timer, automatically and immediately executing the auction based on the highest bid;
wherein the hidden threshold value is hidden to the one or more communication device each coupled to one or more bidders.

2. The method of claim 1, wherein automatically executing the auction includes automatically transferring the withheld money from the buyer.

3. The method of claim 2, wherein withholding from the third party financial institution is one of placing a hold on the funds or placing the funds is a hold account.

4. The method of claim 1, further comprising sending a notification to the communication device that the auction has been executed.

5. The method of claim 1, further comprising automatically matching one or more bidders to the one or more auction postings via artificial intelligence.

6. The method of claim 5, wherein the one or more bidders and the one or more auction postings are dynamically matched to achieve a desired net price by the artificial intelligence squeezing commission from the auction platform.

7. The method of claim 1, further comprising setting a bid budget for each of the one or more bidders, wherein the bid budget includes at least a budget total, one or more bid listings, and one or more completed listings;
comparing the value of each of the one or more bid listings to a budget threshold amount; and
automatically cancelling at least one bid listing where the comparison is above the threshold amount.

8. The method of claim 7, wherein the budget threshold amount is the budget total minus the value of each of the one or more completed listings.

9. The method of claim 7, wherein the budget total and/or the budget threshold amount are determined by artificial intelligence; and
wherein each of the one or more bidders may increase the budget total.

10. The method of claim 1, wherein
a seller associated with the auction may terminate the auction—at any time.

11. The method of claim 1, further comprising after periodically receiving one or more bids;
determining at least one of the bids is not a highest bid;
sending a notification to each bidder associated with the at least one bid that is not the highest bid notifying them that their bid is not the highest bid; and
sending a notification to the bidder associated with the highest bid that they are the highest bid.

12. The method of claim 1, wherein each auction posting further includes a list price.

13. (canceled)

14. A system for hidden threshold auctions comprising:
an auction platform that configured to host a plurality of auction posting, and set an auction timer for each of the one or more auction posting, the auction timer determining a time window for the auction and each auction posting including at least a hidden threshold value;
one or more communication devices each coupled to one or more bidders, wherein the one or more communication devices are communicatively coupled to the auction platform and which displays the list value and which periodically sends one or more bids to the auction platform, each of the one or more bids having a duration of validity after which each of the one or more bids expires;
a third party financial institution communicatively coupled to the auction platform and associated with each of the one or more bidders which sends financial information to the auction platform;
wherein the auction platform is configured to determine a highest bid, automatically withhold from the third party financial institution money up to the highest bid, compare the highest bid against the hidden threshold value in substantially real-time, determine the highest bid exceeds the hidden threshold value, upon determination that the hidden threshold value has been exceeded stops the timer, and upon expiration of the timer automatically and immediately execute the auction based on the highest bid;
wherein the hidden threshold value is hidden to the one or more communication device each coupled to one or more bidders.

15. The system of claim 14, wherein automatically executing the auction includes automatically transferring the withheld money to the associated seller.

16. The system of claim 14, wherein the auction platform further sends a notification to the communication device that the auction has been executed.

17. The system of claim 14, further comprising an artificial intelligence module which automatically matches one or more bidders to the one or more auction postings.

18. The system of claim 17, wherein the one or more bidders and the one or more auction postings are dynamically matched to achieve a desired net price by the artificial intelligence squeezing commission from the auction platform.

19. The system of claim 18, wherein factors considered by the artificial intelligence module include one or more of bid delta relative to undisclosed threshold, bid delta relative to last bid, and/or buyer spending profile.

20. The system of claim 13, wherein the auction platform further determines at least one of the bids is not a highest bid;
sends a notification to each bidder associated with the at least one bid that is not the highest bid notifying them that their bid is not the highest bid; and
sends a notification to the bidder associated with the highest bid that they are the highest bid.

21. The method of claim 1, further comprising automatically determining selling metrics for one or more items associated with the plurality of auction postings based on at least bid amounts, number of bids, average bid price, and expiration of buyer bids; and
suggesting, via artificial intelligence and/or machine learning, an execution threshold and/or list price for the one or more items.
